(19) United States
(12) Patent Application Publication
(10) Pub. No.: US 2025/0014489 A1
(43) Pub. Date: Jan. 9, 2025

(54) DISPLAY DEVICE

(71) Applicant: SAMSUNG DISPLAY CO., LTD., YONGIN-SI (KR)

(72) Inventors: Su Jung HUH, YONGIN-SI (KR); Jeong Woo PARK, YONGIN-SI (KR); Beom Shik KIM, YONGIN-SI (KR); Eun Kyoung NAM, YONGIN-SI (KR); Rang Kyun MOK, YONGIN-SI (KR); Sung Chan JO, YONGIN-SI (KR)

(21) Appl. No.: 18/754,856

(22) Filed: Jun. 26, 2024

(30) Foreign Application Priority Data
Jul. 4, 2023 (KR) 10-2023-0086300

(51) Int. Cl. G09G 3/00; G02B 30/25

(52) U.S. Cl. CPC G09G 3/003; G02B 30/25; G09G 2300/0452; G09G 2320/0209

(57) ABSTRACT

A display device includes a display panel configured to display 2D images, an optical member configured to display the 2D images displayed on the display panel by maintaining display light paths of the 2D images during a 2D image display period, and to display 3D stereoscopic images by refracting the display light paths of the 2D images during a 3D stereoscopic image display period, and a display driver configured to drive the display panel so that the display panel displays multi-view images in the 2D image display period and the 3D stereoscopic image display period, and to apply driving voltages to the optical member to control operations of the optical member for displaying the 2D images or 3D stereoscopic images.

### CROSS-REFERENCE TO RELATED APPLICATION

This patent application claims priority under 35 U.S.C. 119 to Korean Patent Application No. 10-2023-0086300 filed on Jul. 4, 2023 in the Korean Intellectual Property Office, the disclosure of is incorporated by reference in its entirety herein.

### 1. TECHNICAL FIELD

The present disclosure relates to a display device.

### 2. DISCUSSION OF RELATED ART

A three-dimensional (3D) image display device is a display device that can convey depth to the viewer, creating a sense of three-dimensionality. This may be achieved by presenting two slightly different images (e.g., a left-eye image and a right-eye image) to each eye. The brain fuses the two images together to create a perception of depth according to binocular parallax. The images may be provided in the space in front of the display device using an optical member.

The 3D image display device may use a stereoscopic technique or an auto-stereoscopic technique. The stereoscopic technique utilizes parallax images between left and right eyes, which provide large stereoscopic effects. The stereoscopic technique may be realized with or without glasses.

In the stereoscopic technique with glasses, a left-eye image and a right-eye image having different polarizations are displayed, so that a viewer with polarization glasses or shutter glasses can see 3D images. In the glasses-free stereoscopic technique, an optical member such as a parallax barrier and a lenticular lens sheet is formed in a display device, and the optical axis of a left-eye image is separated from the optical axis of a right-eye image, so that a viewer can see 3D images. Unfortunately, glasses-free stereoscopic display devices have the shortcoming that adjacent parallax images overlap one another when the driving characteristics of birefringent materials that refract image display light become deteriorated.

### SUMMARY

An aspect of the present disclosure provides a display device that can increase the driving characteristics of birefringent materials which refract image display lights during a stereoscopic image display period by optimizing an arrangement of driving electrodes of the birefringent materials.

An aspect of the present disclosure also provides a display device that can prevent crosstalk by blocking images distorted at contact areas between optical lenses and side edges of the optical lenses.

According to an embodiment of the disclosure, a display device includes a display panel configured to display 2D images, an optical member, and a display driver. The optical member is configured to display the 2D images displayed on the display panel by maintaining display light paths of the 2D images during a 2D image display period, and to display 3D stereoscopic images by refracting the display light paths of the 2D images during a 3D stereoscopic image display period. The display driver is configured to drive the display panel so that the display panel displays multi-view images in the 2D image display period and the 3D stereoscopic image display period, and to apply driving voltages to the optical member to control operations of the optical member for displaying the 2D images or 3D stereoscopic images.

In an embodiment, the optical member includes first and second optical sheets facing each other, a polarization controller disposed between the first and second optical sheets and formed on a front surface of the first optical sheet, and a plurality of optical lenses formed on a rear surface of the second optical sheet to overlap with the polarization controller between the first and second optical sheets.

In an embodiment, the polarization controller includes at least one first transparent electrode disposed on a front surface of the first optical sheet, a polarization control layer disposed on a front surface of the first transparent electrode, and at least one second transparent electrode disposed to face the at least one first transparent electrode, where the polarization control layer is interposed between the at least one first transparent electrode and the at least one second transparent electrode.

According to an embodiment of the disclosure, a display device includes a display panel configured to display 2D images, an optical member, and a display driver. The optical member is configured to display the 2D images displayed on the display panel by maintaining display light paths of the 2D images during a 2D image display period, and to display 3D stereoscopic images by refracting the display light paths of the 2D images during a 3D stereoscopic image display period. The display driver is configured to control the optical member for changing the light paths between the first and the second linear polarization directions in the second 2D image display period or the 3D stereoscopic image display period. The display driver drives the display panel so that the display panel displays multi-view images in the 2D image display period and the 3D stereoscopic image display period, and to apply driving voltages to the optical member to control operations of the optical member for displaying the 2D images or 3D stereoscopic images.

According to an embodiment of the disclosure, a display device includes an optical member, a polarization controller, and a display driver. The optical member is configured to display 2D images displayed on a display panel by maintaining display light paths of the 2D images during a 2D image display period, and to display 3D stereoscopic images by refracting the display light paths of the 2D images during a 3D stereoscopic image display period. The optical member includes: first and second optical sheets facing each other, a polarization controller disposed between the first and second optical sheets on a front surface of the first optical sheet, and a plurality of optical lenses disposed on a rear surface of the second optical sheet to overlap with the polarization controller between the first and second optical sheets.

According to at least one embodiment of the present disclosure, it is possible to increase the sharpness and display quality of stereoscopic images in a display device by increasing driving characteristics of birefringent materials that refract image display light during a stereoscopic image display period.

According to at least one embodiment of the present disclosure, it is possible to suppress crosstalk in a display device and to increase user satisfaction and reliability by blocking images distorted at contact areas between optical lenses and side edges of the optical lenses.

### BRIEF DESCRIPTION OF THE DRAWINGS

The above and other aspects and features of the present disclosure will become more apparent by describing in detail embodiments thereof with reference to the attached drawings, in which:

FIG. 1 is an exploded, perspective view showing a display device according to an embodiment of the present disclosure.

FIG. 2 is a view showing a display panel and an optical member shown in FIG. 1 when they are attached together.

FIG. 3 is a plan view showing a part of an arrangement structure of sub-pixels in the display area.

FIG. 4 is a plan view showing a part of an arrangement structure of sub-pixels of a display area according to an embodiment.

FIG. 5 is a view showing a method of setting view point information for each sub-pixel according to a lens width of an optical member.

FIG. 6 is a cross-sectional view showing the sub-pixels and the optical member according to an embodiment, taken along line I-I′ shown in FIG. 5.

FIG. 7 is a cross-sectional view showing the sub-pixels and the optical member according to an embodiment, taken along line I-I′ shown in FIG. 5.

FIG. 8 is a cross-sectional view showing the sub-pixels and the optical member shown in FIG. 7 according to an embodiment.

FIG. 9 is a cross-sectional view showing the sub-pixels and the optical member according to an embodiment, taken along line I-I′ shown in FIG. 5.

FIG. 10 is a cross-sectional view showing the sub-pixels and the optical member shown in FIG. 9 according to an embodiment.

FIG. 11 is a diagram showing image display timings during a 2D image display period and a 3D stereoscopic image display period.

FIG. 12 is a diagram showing changes in voltage levels applied to first and second transparent electrodes during a 2D image display period and a 3D stereoscopic image display period.

FIG. 13 is a cross-sectional view showing light exit paths of a polarization control layer and optical lenses of the optical member according to an embodiment during a 2D image display period.

FIG. 14 is a cross-sectional view showing light exit paths of the polarization control layer and the optical lenses of the optical member of FIG. 13 according to an embodiment during a 3D image display period.

FIG. 15 is a cross-sectional view showing the sub-pixels and the optical member according to an embodiment, taken along line I-I′ shown in FIG. 5.

FIG. 16 is a cross-sectional view showing the sub-pixels and the optical member according to an embodiment, taken along line I-I′ shown in FIG. 5.

FIG. 17 is a cross-sectional view showing the sub-pixels and the optical member according to an embodiment, taken along line I-I′ shown in FIG. 5.

FIG. 18 is a cross-sectional view showing light exit paths of the polarization control layer and optical lenses of the optical member according to an embodiment during a 2D image display period.

FIG. 19 is a cross-sectional view showing light exit paths of the polarization control layer and the optical lenses of the optical member according to an embodiment during a 3D image display period.

FIG. 20 is an exploded, perspective view showing a display device according to an embodiment of the present disclosure.

FIG. 21 is a plan view showing the display panel and the optical member shown in FIG. 20.

### DETAILED DESCRIPTION

The present disclosure will now be described more fully hereinafter with reference to the accompanying drawings, in which example embodiments of the disclosure are shown. This disclosure may, however, be embodied in different forms and should not be construed as limited to the embodiments set forth herein. Rather, these embodiments are provided so that this disclosure will be thorough and complete, and will fully convey the scope of the disclosure to those skilled in the art.

It will also be understood that when a layer is referred to as being “on” another layer or substrate, it can be directly on the other layer or substrate, or intervening layers may also be present. The same reference numbers indicate the same components throughout the specification.

Each of the features of the various embodiments of the present disclosure may be combined or combined with each other, in part or in whole, and technically various interlocking and driving are possible. Each embodiment may be implemented independently of each other or may be implemented together in an association.

Hereinafter, embodiments of the present disclosure will be described with reference to the accompanying drawings.

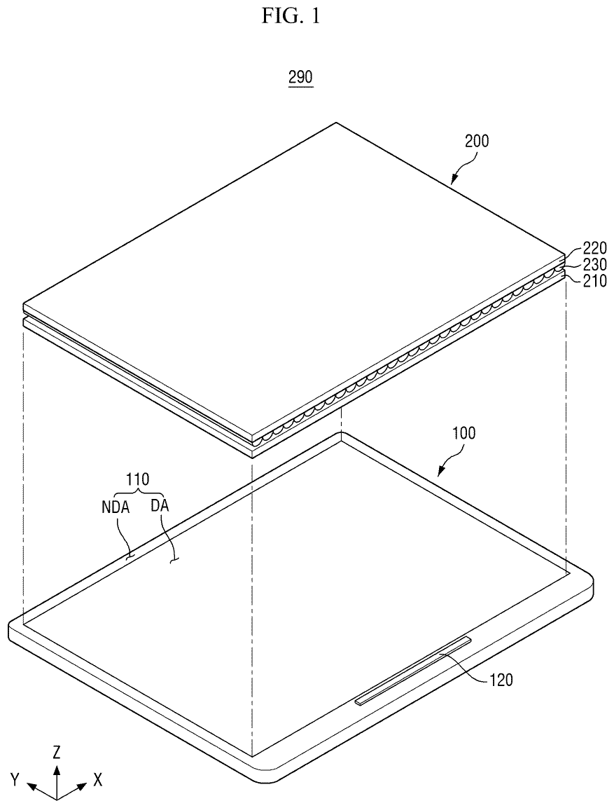

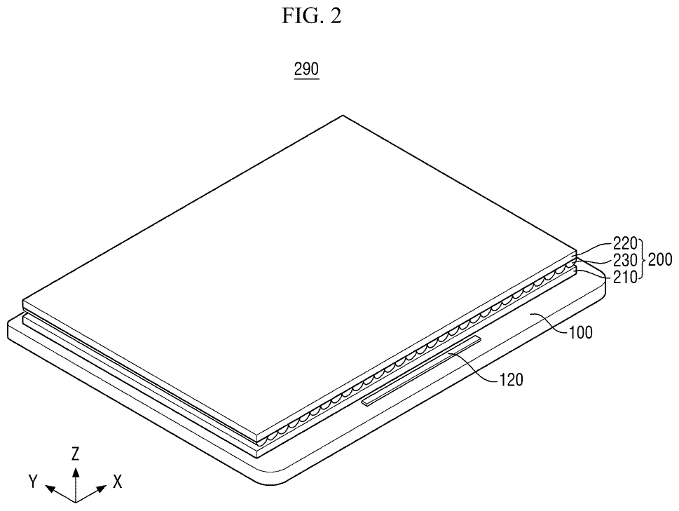

FIG. 1 is an exploded, perspective view showing a display device according to an embodiment of the present disclosure. FIG. 2 is a view showing a display panel and an optical member shown in FIG. 1 when they are attached together.

A display device 290 may be implemented as a flat panel display device such as a liquid-crystal display (LCD) device, a field emission display (FED) device, a plasma display panel (PDP) device, or an organic light-emitting display (OLED) device.

The display device 290 may be a stereoscopic image display device including a display module 100 and an optical member 200, e.g., a 3D image display device. In an embodiment, the 3D image display device separately displays a left-eye image and a right-eye image on its front side to enable a viewer to perceive 3D images utilizing binocular parallax. The 3D image display device may separately provide images at different viewing angles on its front side so that different images are displayed at the different viewing angles.

According to an embodiment of the present disclosure, the display device 290 is a light-field display device that allows different image information to be seen by each viewer eye, by disposing the optical member 200 on the front side of the display module 100. The light-field display device may generate a 3D stereoscopic image by generating a light field by using the display module 100 to display a 2D image and the optical member 200 to convert the 2D image into a 3D image for display. In an embodiment, the light-field display device enables an image display light generated in each pixel in the display module 100 to form a light field directed to a particular direction (a particular viewing angle and/or a particular viewpoint) by stereoscopic lenses, pinholes, or barriers included in the optical member 200. In this manner, 3D stereoscopic image information associated with the particular direction can be provided to the viewer.

The display module 100 may include a display panel 110, a display driver 120 (e.g., a driver circuit), and a circuit board.

The display panel 110 may include a display area DA and a non-display area NDA. The display area DA may include data lines, scan lines, supply voltage lines, and a plurality of pixels connected to the data lines and scan lines. For example, the scan lines may extend in the first direction (x-axis direction) and be spaced apart from one another in the second direction (y-axis direction). The data lines and the supply voltage lines may extend in the second direction (y-axis direction) and be spaced from one another in the first direction (x-axis direction).

Each pixel (or unit pixel) formed and arranged on the display panel 110 includes the minimum number of sub-pixels capable of emitting white light. For example, each pixel may include three sub-pixels emitting red, green and blue light lights, respectively. Each of the pixels arranged sequentially and repeatedly may be connected to at least one scan line, a data line, and a supply voltage line. Each of the sub-pixels may include thin-film transistors including a driving transistor and at least one switching transistor, a light-emitting element, and a capacitor. When a scan signal is applied from a scan line, each of the pixels receives a data voltage from a data line and supplies a driving current to the light-emitting element according to the data voltage applied to the gate electrode, so that light can be emitted.

Herein, the pixels of the display panel 110 (e.g., the unit pixels) display 2D multi-view images according to the order in which the display driver 120 provides image data. The multi-view images include n view images, where n is a natural number equal to or greater than two. Such n view images may be generated by capturing images of an object with n cameras spaced apart from one another by the distance between a person's eyes.

The display panel 110 may display multi-view images in units of n pixels during an image display period. For example, the display panel 110 may display multi-view images in units of two pixels. In other words, two pixels of the display panel 110 may display a multi-view image including two view images. In particular, the display panel 110 may display a multi-view image in units of time-division frames (or sub-frames) according to the time-division driving of the display driver 120. Multi-view images may be displayed in units of two pixels for each time-division frame. In an embodiment, a time-division frame is a period that divides one frame into ½ or ⅓ sub-frames.

The non-display area NDA may be disposed at the edge of the display panel 110 to surround the display area DA. The non-display area NDA may include a scan driver (not shown) that applies scan signals to scan lines, and pads (not shown) connected to the display driver 120. For example, the display driver 120 may be disposed on a side of the non-display area NDA, and the pads may be disposed on one edge of the non-display area NDA on which the display driver 120 is disposed.

The display driver 120 may output control signals and image data voltages for driving the display panel 110 in units of at least one frame or at least one time-division frame (or sub-frame). For example, the display driver 120 may supply image data voltages to the data lines in units of at least one time-division frame (or sub-frame). The display driver 120 supplies a supply voltage to the supply voltage line, and may supply scan control signals to the scan driver.

The optical member 200 includes a plurality of optical lenses (e.g., refractive-index anisotropic lenses 230) formed between first and second optical sheets 210 and 220; and a polarization controller that is stacked on and overlaps with the plurality of optical lenses 230.

In an embodiment, the display driver 120 selects a viewing point and a viewing point number according to the viewing point for each sub-pixel depending on the relative positions between the plurality of optical lenses 230 and the sub-pixels arranged in parallel between the first and second optical sheets 210 and 220 of the optical member 200. In an embodiment, the display driver 120 aligns positions of image data input from an external source for each horizontal line based on the viewing points and the viewing point numbers of the sub-pixels. The display driver 120 may generate image data voltages corresponding to the image data whose arrangement positions are aligned for each horizontal line to supply them to the data lines, so that 3D stereoscopic images are displayed according to the relative arrangement positions of the sub-pixels relative to the optical lenses 230 in addition to the polarization controller.

The display driver 120 may be implemented as an integrated circuit (IC) and may be disposed in the non-display area NDA of the display panel 110 by a chip on glass (COG) technique, a chip on plastic (COP) technique, or ultrasonic bonding. In another example, the display driver 120 may be mounted on a circuit board (not shown) and connected to the pads of the display panel 110.

The optical member 200 may be disposed on the front side of the display panel 110 or the display module 100. The optical member 200 may be attached to a surface of the display panel 110 or the display area DA through an adhesive member. The optical member 200 may be attached to the front surface of the display module 100 by a panel bonding apparatus.

The optical member 200 may include a polarization controller and a plurality of optical lenses 230 formed between the first and second optical sheets 210 and 220 such that they overlap each other and are stacked on each other. The plurality of optical lenses 230 may be arranged in parallel in the form of a lens sheet. In addition, the polarization controller may be disposed such that it overlaps with the plurality of optical lenses 230.

In an embodiment, a polarizing sheet is formed on the rear surface of the first optical sheet 210 or the front surface of the display panel 110, which filters 2D image display light of the display panel 110 to output it through a path in a first linear polarization direction. The polarization controller of the optical member 200 may transmit 2D image display light incident along the paths in the first linear polarization direction through the first optical sheet 210 without changing the paths, or may change the paths of the light into paths in the second linear polarization direction to transmit them.

In an embodiment, the polarization controller transmits a 2D image display light incident via a path in the first linear polarization direction through the first optical sheet 210 without changing the path during the 2D image display period in response to driving control of the display driver 120. In an embodiment, the polarization controller transmits a 2D image display light incident via a path in the first linear polarization direction by changing the path into a path in the second linear polarization direction in response to driving control of the display driver 120.

The plurality of optical lenses 230 in the form of a lens sheet may be configured and arranged to form a path in the first linear polarization direction according to the material of the lenses or the arrangement of birefringent materials (e.g., liquid crystal or slits) included therein. Accordingly, the plurality of optical lenses 230 may transmit the 2D image display light incident along the path in the first linear polarization direction through the polarization controller during the 2D image display period while maintaining the path in the first linear polarization direction. However, when the 2D image display light is incident on the plurality of optical lenses 230 along the paths in the second linear polarization direction through the polarization controller during a 3D image display period, the 2D image display light is refracted toward predetermined viewing points by the material of the lenses or the arrangement of the birefringent materials, and are displayed as 3D images. That is to say, the optical lenses 230 transmit the 2D image display light incident along the paths in the first linear polarization direction while maintaining the paths in the first linear polarization direction, and transmit the 2D image display lights incident along the paths in the second linear polarization direction by refracting the light toward the predetermined viewing points. Accordingly, a 3D stereoscopic image is displayed through the plurality of optical lenses 230 during the 3D image display period.

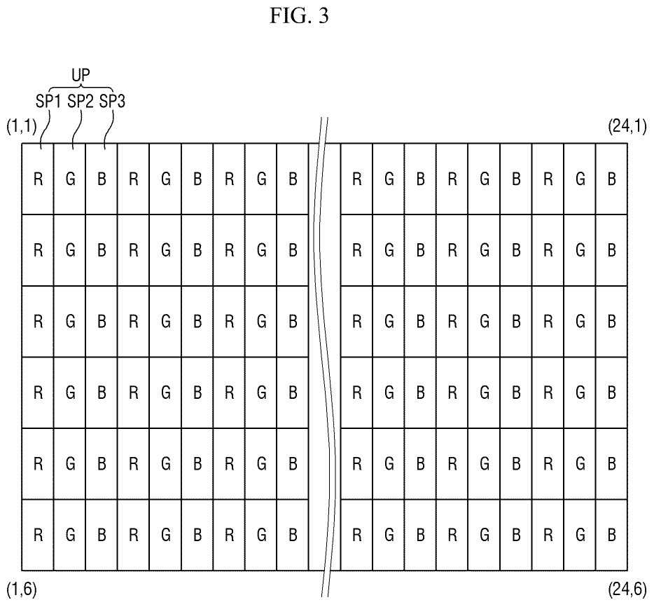

FIG. 3 is a plan view showing a part of the arrangement structure of the sub-pixels in the display area.

FIG. 3 shows the arrangement structure of sub-pixels arranged in six rows and twenty-four columns. Accordingly, the arrangement structure in FIG. 3 includes the sub-pixel located at the first row and the first column to the sub-pixel located at the sixth row and the twenty-fourth column.

Referring to FIG. 3, a plurality of pixels, e.g., a plurality of unit pixels UP is disposed and arranged in the display area DA of the display panel 110. Each of the unit pixels UP includes a plurality of sub-pixels SP1, SP2 and SP3. The sub-pixels SP1, SP2 and SP3 may be arranged along a plurality of rows and a plurality of columns. For example, the sub-pixels SP1, SP2 and SP3 may be arranged in a vertical or horizontal stripe structure. The display area DA may include more unit pixels UP as the resolution of the display device 290 increases.

In an embodiment, each of the unit pixels UP include first to third sub-pixels SP1 SP2 and SP3 displaying different colors. The first to third sub-pixels SP1 SP2 and SP3 may be formed as n data lines and m scan lines intersect each other, where n and mm are natural numbers. Each of the plurality of sub-pixels SP1 SP2 and SP3 may include a light-emitting element and a pixel circuit. The pixel circuit may include a driving transistor, at least one switching transistor and at least one capacitor to drive the light-emitting element of each of the plurality of sub-pixels.

In an embodiment, each of the plurality of unit pixels UP may include one first sub-pixel SP1, one second sub-pixel SP2, and one third sub-pixel SP3. In an embodiment, each of the plurality of unit pixels UP include four sub-pixels, i.e., one first sub-pixel SP1, two second sub-pixels SP2, and one third sub-pixel SP3. The number of sub-pixels included in each unit pixel UP is not limited thereto. The first sub-pixel SP1 may be a red sub-pixel, the second sub-pixel SP2 may be a green sub-pixel, and the third sub-pixel SP3 may be a blue sub-pixel. Each of the first to third sub-pixels SP1 SP2 and SP3 may receive a data signal containing luminance information of red, green or blue light from the display driver 120 and may output light of the respective color.

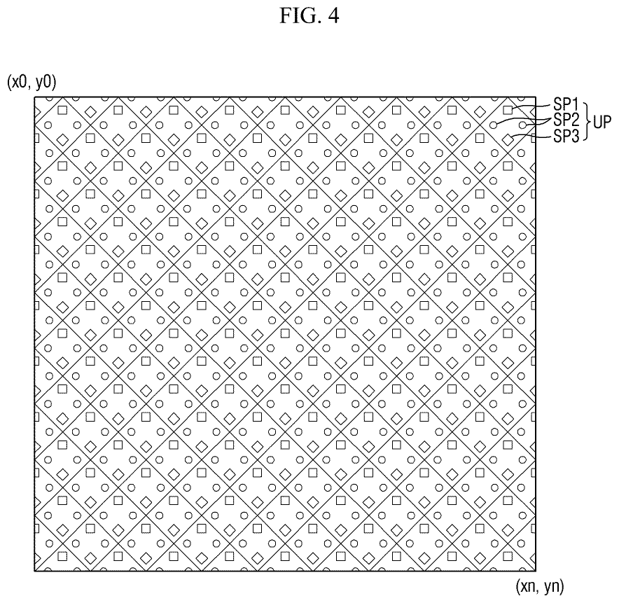

FIG. 4 is a plan view showing a part of an arrangement structure of sub-pixels of a display area according to an embodiment.

Referring to FIG. 4, a plurality of unit pixels UP and a plurality of sub-pixels SP1, SP2 and SP3 may be arranged in the Pentile™ matrix. Specifically, each of the plurality of unit pixels UP may include first to third sub-pixels SP1, SP2 and SP3 arranged in the Pentile™ matrix. The first to third sub-pixels SP1 SP2 and SP3 may be formed as n data lines and m scan lines intersect each other, where n and m are natural numbers which may be different from or equal to each other.

Each of the plurality of unit pixels UP may include, but is not limited to, one first sub-pixel SP1, two second sub-pixels SP2, and one third sub-pixel SP3. The first sub-pixel SP1 may be a red sub-pixel, the second sub-pixel SP2 may be a green sub-pixel, and the third sub-pixel SP3 may be a blue sub-pixel. In an embodiment, each of the first to third sub-pixels SP1, SP2 and SP3 includes an opening. The size of the opening of each of the first to third sub-pixels SP1, SP2 and SP3 may be determined depending on the luminance of the light. Accordingly, the size of the opening of each of the first to third sub-pixels SP1, SP2 and SP3 may be adjusted to represent white light by mixing lights emitted from a plurality of emissive layers. Each of the first to third sub-pixels SP1 SP2 and SP3 may receive a data signal containing luminance information of red, green or blue light from the display driver 120 and may output light of the respective color. The unit pixels UP may have coordinates ranging from (x0, y0) to (xn, yn).

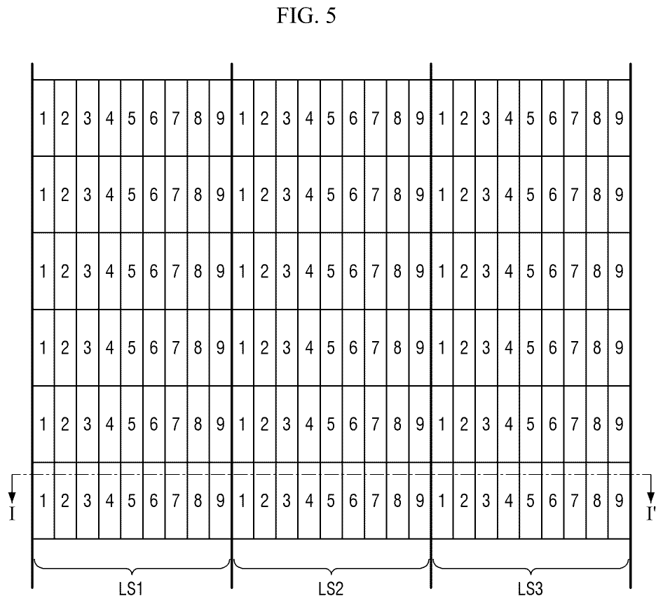

FIG. 5 is a view showing a method of setting view point information for each sub-pixel according to a lens width of an optical member.

Referring to FIG. 5, in an embodiment, viewing point information and a viewing point number for each sub-pixel are set by the width and slanted angle of each of the optical lenses LS1, LS2 and LS3 arranged in parallel between in the first and second optical sheets 210 and 220. In an embodiment, the relative positions of the sub-pixels SP1, SP2 and SP3 overlapping with the optical lenses LS1, LS2 and LS3 are set in an order depending on the width and slanted angle of each of the optical lenses LS1, LS2 and LS3.

For example, the view point information and view point number according to the relative positions of the sub-pixels SP1, SP2 and SP3 overlapping the optical lenses LS1, LS2 and LS3, respectively, may be designated repeatedly in the width direction of the optical lenses LS1, LS2 and LS3 or in the x-axis direction. The view point information VPI or the view point number may be expressed in Equation 1 below:

$$VPI = rownum \times pixelsize \times tan ( slanted angle ) , \qquad [ Equation 1 ]$$

where rownum denotes the number in the horizontal line direction, and pixelsize denotes the width or size of each sub-pixel. In addition, tan (slanted angle) denotes the slanted angle tθ. According to this embodiment, the lenses are arranged in parallel in the y-axis direction (or vertical direction), and thus tan(slanted angle) is equal to 1.

The view point information (or view point number) of the sub-pixels arranged in the first horizontal line and the view point information from the second horizontal line to the last horizontal line are the same in the y-axis direction (or vertical direction).

In an embodiment, the viewing point information for each of the sub-pixels SP1, SP2 and SP3 is designated based on the relative positions of the sub-pixels SP1, SP2 and SP3 of each of the optical lenses LS1, LS2 and LS3, and image display points or viewing points of the display device 290 are designated based on the viewing point information and number of each of the sub-pixels SP1, SP2 and SP3.

As shown in FIG. 5, the image display points or viewing points of the display device 290 may be in line with or lie within the width of each of the optical lenses LS1, LS2 and LS3, and may be set in the same manner as the number and the viewing point numbers of the sub-pixels disposed on the rear surface of each of the optical lenses LS1, LS2 and LS3. In an embodiment, the view points are in line with or lie within the width of the rear surface (or base surface or base side) of each of the optical lenses LS2, LS2 and LS3. If the number of the sub-pixels disposed on the rear surface of each of the optical lenses LS1, LS2 and LS3 is nine, there may be nine different view points for detecting optical properties of the display device 290.

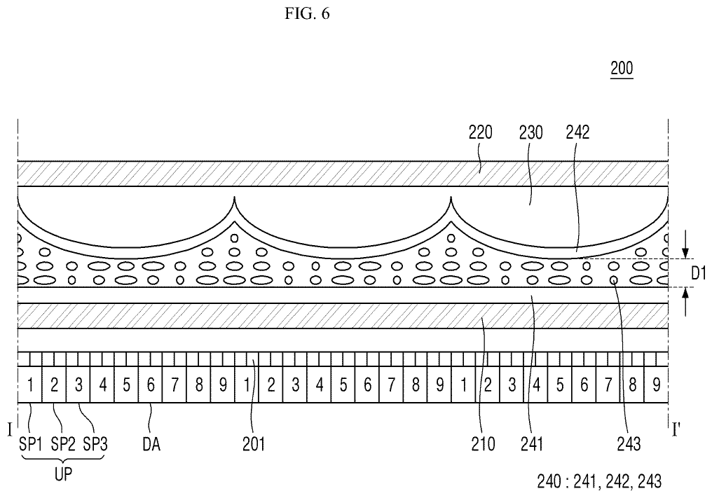

FIG. 6 is a cross-sectional view showing the sub-pixels and the optical member according to an embodiment, taken along line I-I′ shown in FIG. 5.

Referring to FIGS. 5 and 6, the display device 290 includes the display panel 110 that displays 2D images, and the optical member 200 that displays the 2D images either as 2D images or converts them into 3D stereoscopic images to display them.

The first to third sub-pixels SP1, SP2 and SP3 sequentially arranged in the display area DA of the display panel 110 display 2D multi-view images. For example, during a 2D image display period and a 3D stereoscopic image display period, the first to third sub-pixels SP1, SP2 and SP3 may display 2D multi-view images in units of at least two adjacent sub-pixels or unit pixels. In an embodiment, at least two adjacent sub-pixels or unit pixels display a multi-view image including two view images. In an embodiment, the first to third sub-pixels SP1, SP2 and SP3 of the display panel 110 emit 2D image display light in the first linear polarization direction to the front side according to the orientations of a polarizer or a polarizing sheet 201 on the front side.

In an embodiment, the polarizing sheet 201 may be attached and formed on the front surface of the display panel 110. In an embodiment, the polarizing sheet 201 is attached to the rear surface of the optical member 200 facing the front surface of the display panel 110 or is included in the inner surface of the optical member 200. The polarizing sheet 201 converts the 2D image display light of the display panel 110 into light in a path (e.g., a display light path) in a predetermined first or second linear polarization direction to transmit the converted light therethrough. According to an embodiment of the present disclosure, the polarizing sheet 201 converts the 2D image display light of the display panel 110 into light in a path in the first linear polarization direction to transmit the converted light therethrough.

The optical member 200 displays the 2D image while maintaining the display light path of the 2D image displayed in the display area DA of the display panel 110 during the 2D image display period, and displays a 3D stereoscopic image by refracting the display light path of the 2D image during the 3D stereoscopic image display period.

In an embodiment, during the 2D image display period, the optical member 200 outputs the display light of the 2D images displayed in the display area DA of the display panel 110 along the light paths in the first linear polarization direction without changing the paths under the control of the display driver 120. In an embodiment, during the 3D stereoscopic image display period, the optical member 200 converts the display light of the 2D image displayed in the display area DA into a light path in the second linear polarization direction and refracts it under the control of the display driver 120, to output the light and display a 3D stereoscopic image.

In an embodiment, the display driver 120 divides each frame for displaying an image into first and second time-division frames, and applies first driving voltages to the optical member 200 every first and second time-division frames during the period in which 2D images are displayed. When the unit pixels UP of the display area DA are driven in this manner, 2D images are displayed in the display area DA.

During the 2D image display period, the optical member 200 outputs the display light of the 2D images displayed in the display area DA along the light paths in the first linear polarization direction without changing the paths in response to the first driving voltages input from the display driver 120. As a result, the 2D image is displayed through the display panel 110 and the optical member 200 during the 2D image display period.

In an embodiment, during the 3D stereoscopic image display period, the display driver 120 divides each frame for displaying 3D stereoscopic images into first and second time-division frames, and applies first and second driving voltages to the optical member 200 every first and second time-division frames. In an embodiment, the first driving voltages are different from the second driving voltages and there is a predetermined voltage difference between the first and second driving voltages. For example, the first and second driving voltages may be voltages of different levels having a predetermined voltage difference of 1 V or more (e.g., a voltage difference of 2.5 V or 5 V). In an embodiment, during the 3D stereoscopic image display period, the display driver 120 displays a multi-view image including two 2D view images by driving each unit pixel UP every first and second time-division frames.

In an embodiment, during the 3D stereoscopic image display period, the optical member 200 in response to the first and second driving voltages input from the display driver 120, converts the display light of the 2D images displayed in the display area DA into light paths in the second linear polarization direction and refracts them, to output the light and display 3D stereoscopic images. Accordingly, during the 3D image display period, 2D images are refracted through the optical member 200 and displayed as 3D stereoscopic images.

As shown in FIG. 6, the optical member 200 includes a polarization controller 240 and a plurality of optical lenses (e.g., refractive-index anisotropic lenses 230) between the first and second optical sheets 210 and 220, which overlap with each other and are stacked on each other.

In an embodiment, the polarization controller 240 is disposed between the first and second optical sheets 210 and 220, on the front surface of the first optical sheet 210. In an embodiment, the optical lenses 230 are formed between the first and second optical sheets 210 and 220, on the rear surface of the second optical sheet 220 such that they overlap with and are stacked on the polarization controller 240.

In an embodiment, the first optical sheet 210 is disposed on the entire surface of the display area DA in the shape of a flat plate. One surface of the first optical sheet 210 and the opposite surface of the first optical sheet 210 may be parallel to each other. The first optical sheet 210 may transmit light incident from the display area DA so that the light exits as it is. In other words, the linear polarization direction of the 2D image display light passing through the rear surface of the first optical sheet 210 is maintained in the same linear polarization direction it had while passing through the front surface of the first optical sheet 210.

The polarization controller 240 is formed on the front surface of the first optical sheet 210. When first driving voltages are input from the display driver 120, the polarization controller 240 transmits the display light of the 2D image displayed in the display area DA via the light path in the first linear polarization direction to the front side without changing it. In addition, when the first driving voltage and the second driving voltage are input from the display driver 120, the display light of the 2D image displayed in the display area DA is converted into a light path in the second linear polarization direction and is output. For example, the first linear polarization direction may refer to the direction of light traveling while oscillating in the z-axis direction, and the second linear polarization direction may refer to the direction of light traveling while oscillating in the x-axis direction.

In an embodiment, the polarization controller 240 includes at least one first transparent electrode 241 formed on the front surface of the first optical sheet 210, a polarization control layer 243 formed on the front surface of the first transparent electrode 241, and at least one second transparent electrode 242 disposed to face the at least one first transparent electrode 241 with the polarization controller 240 therebetween.

At least one first transparent electrode 241 may be formed in a polygonal shape such as a triangle, a quadrangle and a pentagon when viewed from the top, or may be formed in at least one flat plate shape or a plurality of bar shapes. Under the control of the display driver 120, a first or second driving voltage is supplied to at least one first transparent electrode 241 through the display driver 120 or a separate voltage supply. For example, the first driving voltage of 0 V or 1 V may be applied to the at least one first transparent electrode 241 through the display driver 120 or a separate voltage supply.

In an embodiment, at least one second transparent electrode 242 is disposed to face the at least one first transparent electrode 241 in parallel with the polarization controller 240 therebetween. The at least one second transparent electrode 242 may be formed in a flat plate shape or a plurality of bar shapes so that it faces the at least one first transparent electrode 241 in parallel.

In addition, the at least one second transparent electrode 242 may be formed on the surfaces of the plurality of optical lenses 230 so that it faces the at least one first transparent electrode 241 in parallel. For example, the at least one second transparent electrode 242 may cover the surfaces of the plurality of optical lenses 230 so that it faces the at least one first transparent electrode 241 in parallel. Since the at least one second transparent electrode 242 is formed to cover the plurality of optical lenses 230 on the rear or front side, the minimum distance D1 between the at least one first transparent electrode 241 and the at least one second transparent electrode 242 may smaller than the width, height or thickness of each optical lens 230.

The minimum distance D1 between the at least one first transparent electrode 241 and the at least one second transparent electrode 242 may be predetermined based on the width, height or thickness of each optical lens 230. For example, the minimum distance D1 between the at least one first transparent electrode 241 and the at least one second transparent electrode 242 may be determined so that it is less than the width, height, or thickness of each optical lens 230.

In an embodiment, the polarization control layer 243 is formed between the at least one first transparent electrode 241 and the at least one second transparent electrode 242. The polarization control layer 243 includes at least one type of birefringent material. For example, the polarization control layer 243 may include a plurality of liquid crystals (or a liquid crystal layer) having refractive index anisotropy. The birefringent materials included in the polarization control layer 243 form light paths in the first linear polarization direction if the voltage level of the first and second transparent electrodes 241 and 242 are equal to one another or less than a predetermined voltage difference. On the other hand, if a voltage difference between the first and second transparent electrodes 241 and 242 becomes greater than the predetermined voltage difference, light paths in the second linear polarization direction are formed.

When the minimum distance D1 between the first transparent electrode 241 and the second transparent electrode 242 is narrow, the polarization control layer 243 may include birefringent materials having a low viscosity and may use birefringent materials having a high refractive index anisotropy. For example, according to an embodiment of the present disclosure, if the minimum distance D1 between the first transparent electrode 241 and the second transparent electrode 242 is less than the height or thickness of each optical lens 230, birefringent materials having a viscosity of less than 395 millipascal-seconds mpas (e.g., approximately 135 mpas) may be used. In an embodiment, birefringent materials having a refractive index anisotropy greater than 0.4 Δε (e.g., 10 Δε or more) are used.

The polarization control layer 243 maintains or converts the linear polarization direction of the 2D image display light by using birefringent materials having birefringence that is variable depending on a voltage difference between the first transparent electrode 241 and the second transparent electrode 242. For example, if the voltage levels of the first transparent electrode 241 and the second transparent electrode 242 are equal to one another or are maintained below a predetermined voltage difference, the polarization control layer 243 transmit the 2D image display light incident along the light paths in the first linear polarization direction from the rear side to the front side without changing the light paths. In an embodiment, the display driver 120 applies the same (or similar) first driving voltages to the first and second transparent electrodes 241 and 242 during the 2D image display period to maintain the polarization direction of the polarization control layer 243.

However, if the voltage levels of the first transparent electrode 241 and the second transparent electrode 242 vary beyond a predetermined voltage difference, the polarization control layer 243 converts the light paths of 2D image display light incident from the rear side in the first linear polarization (⊗) direction into the light paths in the second linear polarization (↔) direction, to output the light to the front side. As described above, the first linear polarization direction may refer to the direction of light traveling while oscillating in the z-axis direction, and the second linear polarization direction may refer to the direction of light traveling while oscillating in the x-axis direction.

In an embodiment, the display driver 120 applies the first driving voltage to the first transparent electrode 241 and applies the second driving voltage to the second transparent electrode 242 every first and second time-division frames during the 3D stereoscopic image display period to change the polarization direction of the polarization control layer 243. As described above, the first and second driving voltages are voltages of different levels having a predetermined voltage difference.

The plurality of optical lenses 230 is formed on the rear side of the second optical sheet 220 disposed parallel to the first optical sheet 210 such that they overlap with and are stacked on the polarization controller 240. The plurality of optical lenses 230 may have a hemispherical cross section and may be formed in a circular or bar shape when viewed from the top. In an embodiment, the optical lenses 230 have flat rear surfaces attached to the rear surface of the second optical sheet 220 and convex hemispherical surfaces facing the polarization controller 240. The plurality of optical lenses 230 may form light propagation paths in the first linear polarization direction according to the orientations of the birefringent material of the optical lenses 230 themselves or the birefringent material such as liquid crystal and slits included inside the optical lenses 230. For example, the plurality of optical lenses 230 may be formed by aligning the tilt or the direction of the longer axes of liquid crystals, or the direction of arrangement and tilt of the slits in the first linear polarization direction and then curing them. In an embodiment, each of the optical lenses 230 has a half-cylindrical shape.

In an embodiment, the plurality of optical lenses 230 are slanted lenses inclined by a predetermined angle from the side of each of the plurality of sub-pixels in the display area DA or half-cylindrical lenses. The predetermined angle may be designed to prevent colored lines of the display device 290 from being perceived by a viewer. In another example, the plurality of optical lenses 230 are Fresnel Lenses. However, the shape or type of each of the optical lenses 230 is not limited thereto.

When 2D image display light is incident on the convex spherical surfaces of the optical lenses 230 along the paths in the first linear polarization direction, the 2D image display light in the first linear polarization direction passes through them in the first linear polarization direction according to the refractive index in the shorter axis direction of the optical lenses 230. In other words, during the 2D image display period, the polarization controller 240 transmits the display light of the 2D images displayed in the display area DA to the front side in the light paths in the first linear polarization direction without changing the paths, so that the optical lenses 230 also transmit the display light of the 2D images in the light paths in the first linear polarization direction to the front side.

In an embodiment, when 2D image display light is incident on the plurality of optical lenses 230 along light paths in the second linear polarization layer direction, the 2D image display light is refracted by the refractive index of the optical lenses 230 forming the first linear polarization direction toward the viewing points. That is to say, during the 3D stereoscopic image display period, the polarization controller 240 converts the display light of the 2D images displayed in the display area DA into the light paths in the second linear polarization direction and transmits the converted light therethrough. Accordingly, the 2D image display light incident on the plurality of optical lenses 230 during the 3D stereoscopic image display period are refracted toward the respective viewing points by the refractive index of the optical lenses 230 and are displayed as a 3D stereoscopic image.

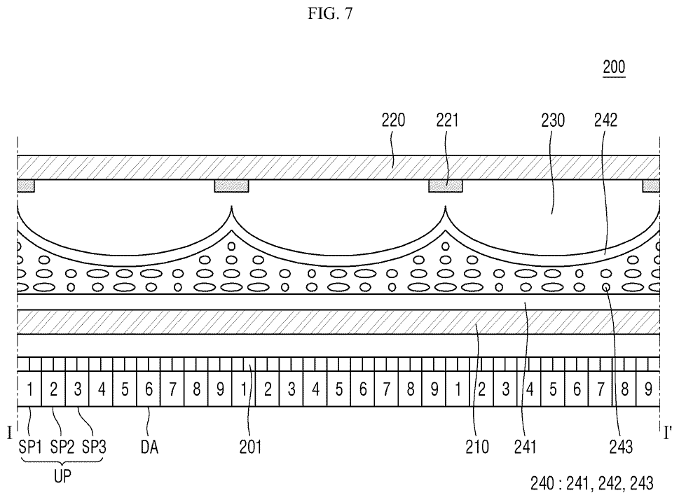

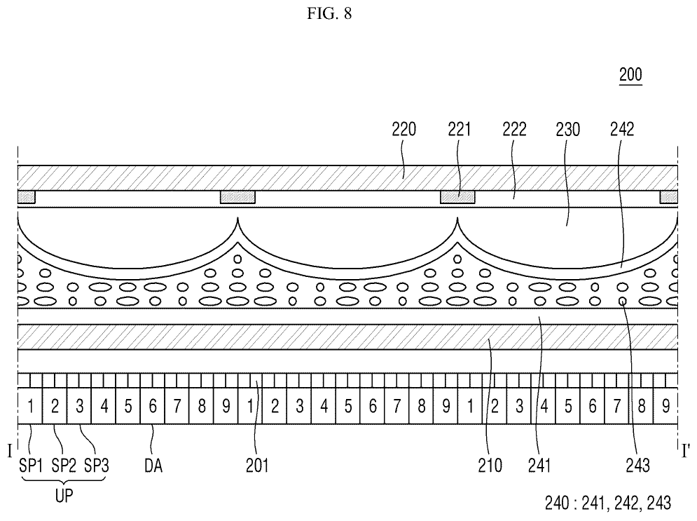

FIG. 7 is a cross-sectional view showing the sub-pixels and the optical member according to an embodiment, taken along line I-I′ shown in FIG. 5. FIG. 8 is a cross-sectional view showing the sub-pixels and the optical member shown in FIG. 5 according to an embodiment.

Initially, as shown in FIG. 7, the optical member 200 may further include a plurality of light-blocking patterns 221 formed on the rear side of the second optical sheet 220 in line with the contact surfaces between adjacent optical lenses 230 and the side edges of the optical lenses 230.

The optical lenses 230 are disposed on the rear side of the second optical sheet 220 on which the plurality of light-blocking patterns 221 are formed.

A spherical aberration of each optical lens 230 may cause light exit angles to be non-uniform at the contact areas between the adjacent optical lenses 230 and the side edges of the optical lens 230. Accordingly, images may be distorted at the contact areas between the optical lenses 230 and at the side edges of the optical lenses 230. In an embodiment, a plurality of light-blocking patterns 221 are formed on the rear side of the second optical sheet 220 to block the distorted image display light on the rear side of the optical lenses 230 where the second optical sheet 220 is disposed. In an embodiment, a light-blocking pattern 221 overlaps a contact area between two adjacent optical lenses 230 and overlaps a small part of the two adjacent optical lenses 230. In an embodiment, the light-blocking patterns 221 contacts the optical lenses 230.

Referring to FIG. 8, the optical member 200 may further include a planarization layer 222 that provides a flat surface over all of the plurality of light-blocking patterns 221 formed on the rear side of the second optical sheet 220. The planarization layer 222 may be formed as a transparent inorganic layer. The optical lenses 230 may be disposed on the flat surface provided by the planarization layer 222 on the rear side of the second optical sheet 220. In an embodiment, the planarization layer 222 covers the light-blocking patterns 221.

The images distorted at the contact areas between the optical lenses 230 and at the side edges of the optical lenses 230 can be blocked by the plurality of light-blocking patterns 221 formed on the rear side of the second optical sheet 220.

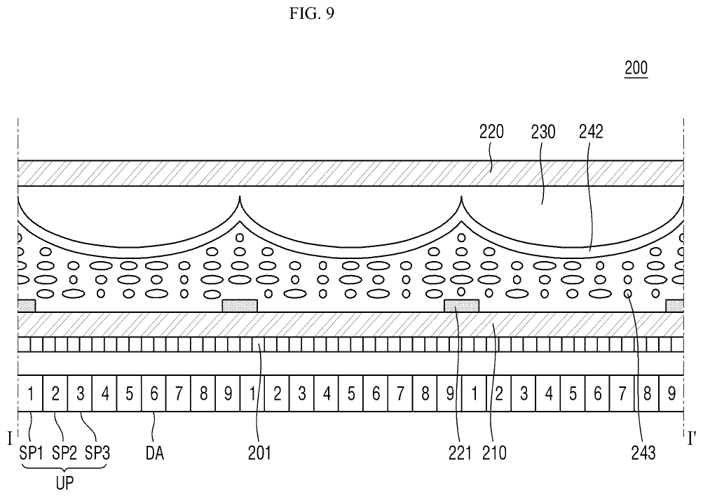

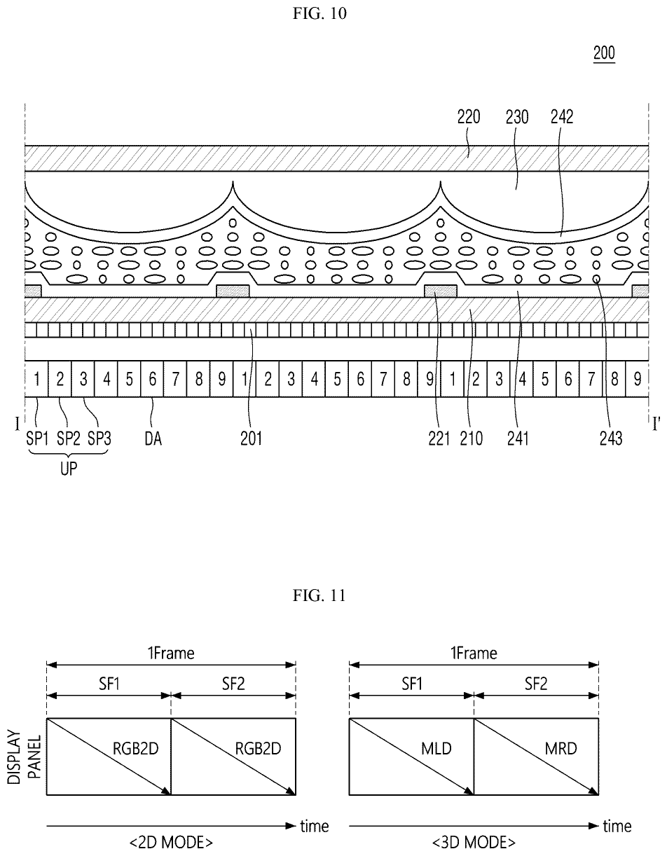

FIG. 9 is a cross-sectional view showing the sub-pixels and the optical member according to an embodiment, taken along line I-I′ shown in FIG. 5. FIG. 10 is a cross-sectional view showing the sub-pixels and the optical member shown in FIG. 9 according to an embodiment.

Referring to FIG. 9, a plurality of light-blocking patterns 221 may be formed on the front side of the first optical sheet 210 in line with the contact surfaces between adjacent optical lenses 230 and the side edges of the optical lenses 230. In an embodiment, the light-blocking patterns 221 are made of the same light-blocking material as a black matrix formed on the display panel 110 or may be formed as a light-blocking film.

Referring to FIG. 10, the optical member 200 may further include a passivation layer that covers the light-blocking patterns 221 formed on the front side of the first optical sheet 210 to protect the light-blocking patterns 221. The passivation layer may be formed as a transparent inorganic layer.

The first transparent electrode 241 of the polarization controller 240 may be formed on the front side of the first optical sheet 210 including the plurality of light-blocking patterns 221 and the passivation layer.

A spherical aberration of each optical lens 230 may cause the light exit angles to be non-uniform at the contact areas between the adjacent optical lenses 230 and the side edges of the optical lenses 230. Accordingly, a plurality of light-blocking patterns 221 may be formed on the side where the first optical sheet 210 is disposed so that image display light is not incident at the contact areas between the optical lenses 230 and at the side edges of the optical lenses 230.

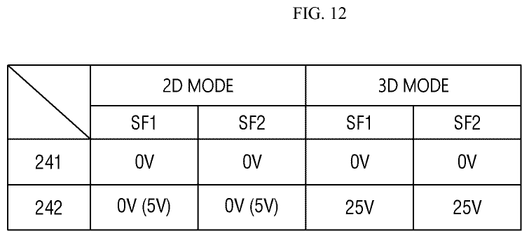

FIG. 11 is a diagram showing image display timings during a 2D image display period and a 3D stereoscopic image display period. FIG. 12 is a diagram showing changes in voltage levels applied to first and second transparent electrodes during a 2D image display period and a 3D stereoscopic image display period.

Referring to FIG. 11, the display driver 120 may divide an image display period 1Frame for each frame into first and second sub-frames SF1 and SF2 during the 2D image display period (2D mode period), and may supply 2D image data voltages RGB2D for displaying 2D images to the data lines of the display panel 110 in the first and second sub-frames SF1 and SF2. Accordingly, the display panel 110 may be driven at a frequency twice the input frame frequency. The frame frequency is 60 Hz for the National Television Standards Committee (NTSC), and is 50 Hz for the Phase-Alternating Line (PAL) specifications. For example, the frame frequency of the display panel 110 may be driven at 120 Hz, which is twice the frame frequency of the input image for the NTSC.

Referring to FIG. 12, the display driver 120 may apply the same first driving voltages to the first transparent electrode 241 and the second transparent electrode 242 during the 2D image display period. For example, the display driver 120 may generate the first driving voltage so that the first driving voltage is maintained below a predetermined level of 0 V or 5 V, to apply it to the first transparent electrode 241 and the second transparent electrode 242.

Referring to FIG. 11, during the 3D stereoscopic image display period in which stereoscopic images such as multi-view images are displayed, the display driver 120 may divide each frame 1Frame into first and second sub-frames SF1 and SF2, and may apply 3D image data voltages MLD and MRD for displaying 3D stereoscopic images to the data lines of the display panel 110 in the first and second sub-frames SF1 and SF2. The MLD image data voltages may be left-eye 3D image data voltages and the MRD image data voltages may be right-eye 3D image data voltages.

Referring to FIG. 12, in an embodiment, during a 3D stereoscopic image display period, the display driver 120 provides a first driving voltage to the first transparent electrodes 241 and a second driving voltage to the second transparent electrodes 242, which is larger than the first driving voltage by a predetermined voltage difference or more. In other words, the display driver 120 may generate the first and second driving voltages to provide them to the first transparent electrodes 241 and the second transparent electrodes 242, respectively, so that the difference between the first driving voltage of the first transparent electrodes 241 and the second driving voltage of the second transparent electrodes 242 is maintained at the predetermined voltage difference (e.g., 15 V) or more.

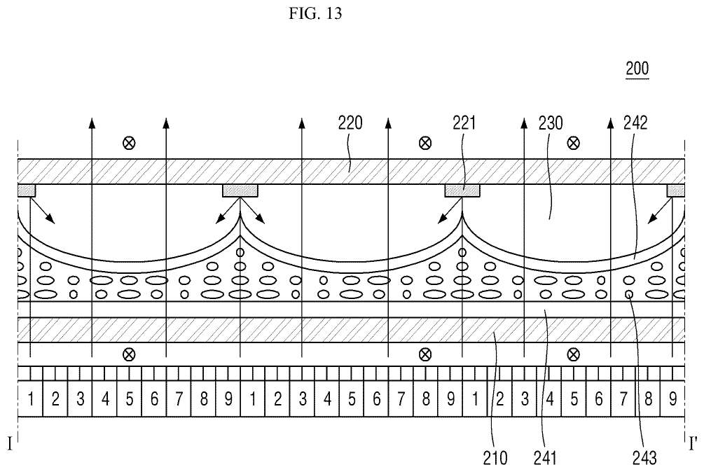

FIG. 13 is a cross-sectional view showing a polarization controller and light exit paths of optical lenses of an optical member according to an embodiment during a 2D image display period.

Referring to FIG. 13, during a 2D image display period, the display driver 120 provides 2D image data voltages RGB2D for displaying a 2D image for each first frame period 1Frame or the first and second sub-frames SF1 and SF2 to the data lines of the display panel 110.

All of the first to third sub-pixels SP1, SP2 and SP3 disposed in the display area DA of the display panel 110 may emit 2D image display light in the first linear polarization light (⊗) direction to the front side according to the orientations of the polarizing sheet 201 disposed on the front surface.

During the 2D image display period, the display driver 120 may generate the first driving voltages so that the first driving voltages are maintained below a predetermined level of 0 V or 5 V, to apply them to the first transparent electrode 241 and the second transparent electrode 242. Accordingly, the polarization control layer 243 transmits the 2D image display light incident via the light paths in the first linear polarization (⊗) direction from the rear side to the front side without changing the light paths.

The 2D image display light in the first linear polarization (⊗) direction which have passed through the polarization control layer 243 are incident on the convex spherical surfaces of the optical lenses 230. Accordingly, when incident on the convex spherical surfaces of the optical lenses 230 along the paths in the first linear polarization direction, the 2D image display light in the first linear polarization (⊗) direction pass through these surfaces in the first linear polarization (⊗) direction according to the refractive index in the shorter axis direction of the optical lenses 230. As a result, the 2D image is displayed through the display panel 110 and the optical member 200 during the 2D image display period.

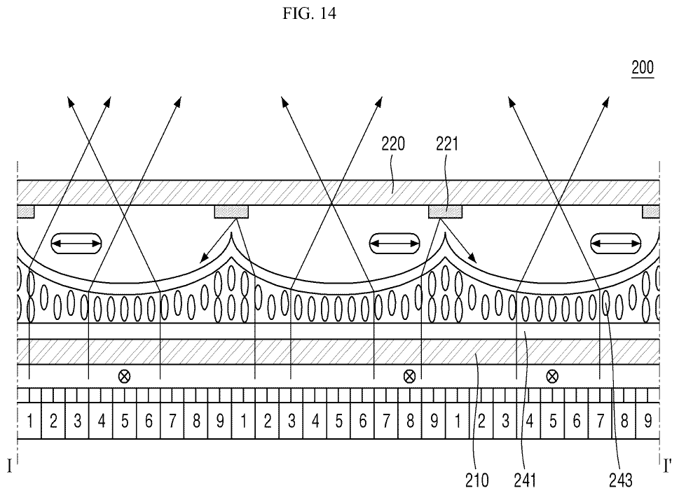

FIG. 14 is a cross-sectional view showing light exit paths of a polarization controller and optical lenses of an optical member according to an embodiment during a 3D image display period.

Referring to FIG. 14, during a 3D stereoscopic image display period, the display driver 120 provides 3D image data voltages (e.g., MLD and MRD) for displaying a 3D stereoscopic image for each first frame period 1Frame or the first and second sub-frames SF1 and SF2 to the data lines of the display panel 110.

All of the first to third sub-pixels SP1, SP2 and SP3 disposed in the display area DA of the display panel 110 may emit 2D image display light in the first linear polarization (⊗) direction to the front side according to the orientations of the polarizing sheet 201 disposed on the front surface.

The display driver 120 may generate the first and second driving voltages to provide them to the first transparent electrodes 241 and the second transparent electrodes 242, respectively, so that the difference between the first driving voltage and the second driving voltage is maintained at the predetermined voltage difference or more.

When the voltage level between the first transparent electrode 241 and the second transparent electrode 242 is maintained at the predetermined voltage difference or more, the polarization control layer 243 converts the light paths of 2D image display lights incident from the rear side in the first linear polarization (⊗) direction into the second linear polarization (↔) direction, to output the light to the front side. Herein, the first linear polarization direction (⊗) may refer to the direction of light traveling while oscillating in the z-axis direction, and the second linear polarization direction (↔) may refer to the direction of light traveling while oscillating in the x-axis direction.

When 2D image display light is incident on the plurality of optical lenses 230 along light paths in the second linear polarization layer (↔) direction, the 2D image display light is refracted by the refractive index of the optical lenses 230 forming the first linear polarization (⊗) direction toward the respective viewing points. That is to say, during the 3D stereoscopic image display period, the polarization controller 240 converts the display light of the 2D images displayed in the display area DA into the light paths in the second linear polarization (↔) direction and transmits the converted light therethrough. Accordingly, the 2D image display light incident on the plurality of optical lenses 230 during the 3D stereoscopic image display period are refracted toward the respective viewing points by the refractive index of the optical lenses 230 and are displayed as 3D stereoscopic images.

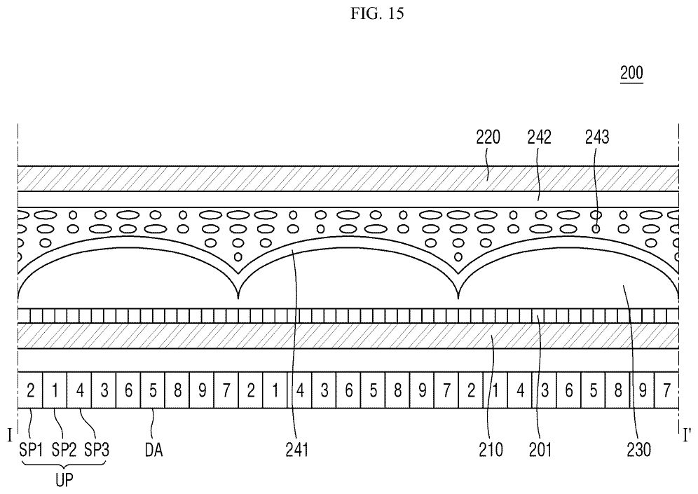

FIG. 15 is a cross-sectional view showing the sub-pixels and the optical member according to an embodiment, taken along line I-I′ shown in FIG. 5.

As shown in FIG. 15, the optical member 200 includes a plurality of optical lenses 230 and a polarization controller 240 between the first and second optical sheets 210 and 220, which overlap each other and are stacked on each other.

In an embodiment, the optical lenses 230 are disposed between the first and second optical sheets 210 and 220, on the front surface of the first optical sheet 210. In an embodiment, the polarization controller 240 is formed between the first and second optical sheets 210 and 220, on the rear surface of the second optical sheet 220 such that it overlaps with the plurality of optical lenses 230 and is stacked thereon.

In an embodiment, the polarizing sheet 201 is attached and formed on the front surface of the first optical sheet 210. In this embodiment, the plurality of optical lenses 230 may be disposed on a front surface of the polarizing sheet 201.

In an embodiment, the optical lenses 230 have flat rear surfaces attached to the front surface of the first optical sheet 210 and convex hemispherical surfaces facing the polarization controller 240. The plurality of optical lenses 230 may form light propagation paths in the first linear polarization direction according to the orientations of the birefringent material of the optical lenses 230 themselves or the birefringent material such as liquid crystal and slits included inside the optical lenses 230.

The polarization controller 240 is formed on the front side of the optical lenses 230. When the first driving voltages from the display driver 120 are input to the first and second transparent electrodes 241 and 242, the polarization controller 240 transmits the 2D image display lights incident through the optical lenses 230 while maintaining the light paths in the first linear polarization direction to the front side.

In an embodiment, when the first driving voltage and the second driving voltage from the display driver 120 are input to the first transparent electrodes 241 and the second transparent electrodes 242 respectively, the polarization control layer 243 interposed between the first transparent electrodes 241 and the second transparent electrodes 242 is converted to have a refractive index in the longer axis direction of birefringent material such as liquid crystals. When 2D image display light in the first linear polarization (⊗) direction is incident on the polarization controller 240 through the optical lenses 230, the polarization control layer 243 has the refractive index in the longer axis direction of liquid crystals, and thus the 2D image display light in the first linear polarization (⊗) direction is refracted toward the respective viewing points in the polarization control layer 243 and at the boundary between the polarization control layer 243 and the optical lenses 230, to exit in the refracted directions, respectively.

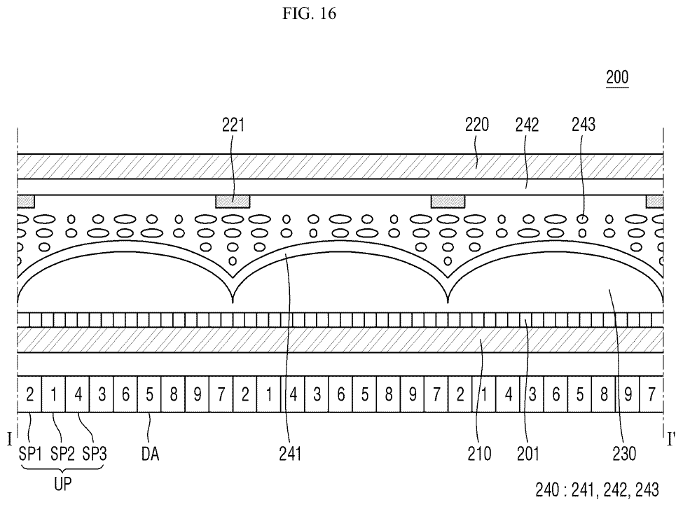

FIG. 16 is a cross-sectional view showing the sub-pixels and the optical member according to an embodiment, taken along line I-I′ shown in FIG. 5.

As shown in FIG. 16, the optical member 200 may further include a plurality of light-blocking patterns 221 formed on the rear side of the second optical sheet 220 in line with the contact surfaces between adjacent optical lenses 230 and the side edges of the optical lenses 230.

The plurality of light-blocking patterns 221 are arranged to block the image display light that is distorted at the contact areas between the optical lenses 230 and the side edges of the optical lenses 230 on the rear side of the optical lenses 230 where the second optical sheet 220 is disposed.

The optical member 200 may further include a planarization layer 222 that provides a flat surface over all of the plurality of light-blocking patterns 221 formed on the rear side of the second optical sheet 220. The planarization layer 222 may be formed as a transparent inorganic layer. A polarization controller 240 may be disposed on the flat surface provided by the planarization layer 222 on the rear side of the second optical sheet 220. In an embodiment, the light-blocking patterns 221 are disposed within a polarization control layer 243 of the polarization controller 240 to contact a second transparent electrode 242.

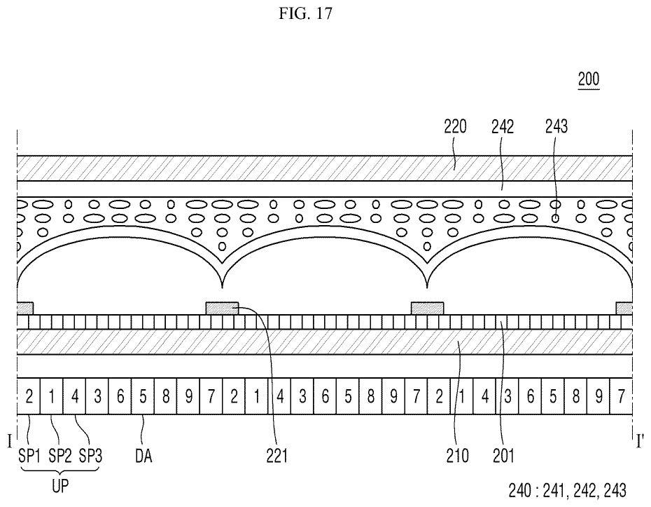

FIG. 17 is a cross-sectional view showing the sub-pixels and the optical member according to an embodiment, taken along line I-I′ shown in FIG. 5.

Referring to FIG. 17, a plurality of light-blocking patterns 221 may be formed on the front side of the first optical sheet 210 in line with the contact surfaces between adjacent optical lenses 230 and the side edges of the optical lenses 230. For example, a light-blocking pattern 221 may overlap a contact area between adjacent optical lenses 230 or the side edge of one of the optical lenses 230.

As described above, the spherical aberration of each optical lens 230 may cause the light exit angles to be non-uniform at the contact areas between the adjacent optical lenses 230 and the side edges of the optical lenses 230. Accordingly, a plurality of light-blocking patterns 221 may be formed on the side where the first optical sheet 210 is disposed so that image display light is not incident at the contact areas between the optical lenses 230 and at the side edges of the optical lenses 230.

In addition, the optical member 200 may further include a planarization layer 222 that provides a flat surface over all of the plurality of light-blocking patterns 221 formed on the front side of the first optical sheet 210. The planarization layer 222 may be formed as a transparent inorganic layer.

The optical lenses 230 may be disposed on the flat surface provided by the planarization layer 222 on the front side of the first optical sheet 210.

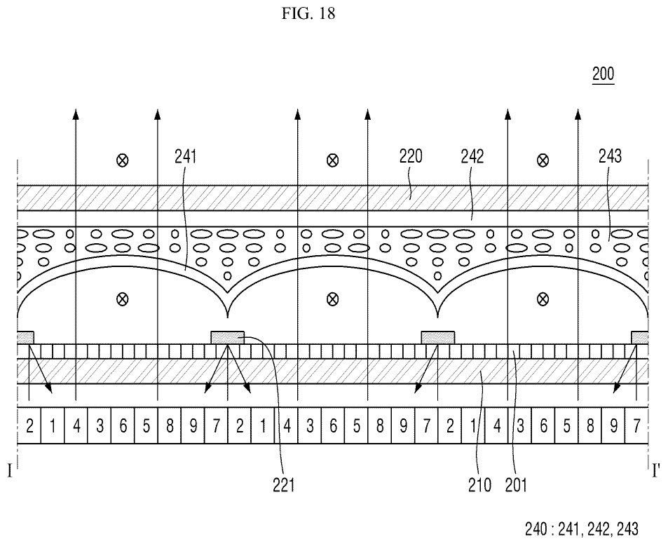

FIG. 18 is a cross-sectional view showing light exit paths of a polarization controller and optical lenses of an optical member according to an embodiment during a 2D image display period.

Referring to FIG. 18, during a 2D image display period, the display driver 120 provides 2D image data voltages RGB2D for displaying a 2D image for each first frame period 1Frame or the first and second sub-frames SF1 and SF2 to the data lines of the display panel 110.

All of the first to third sub-pixels SP1, SP2 and SP3 disposed in the display area DA of the display panel 110 may emit 2D image display light in the first linear polarization light (⊗) direction to the front side according to the orientations of the polarizing sheet 201 disposed on the front surface.

The 2D image display light in the first linear polarization (⊗) direction which has passed through the polarizing sheet 201 is incident on the rear surfaces of the optical lenses 230. The 2D image display light in the first linear polarization (⊗) direction incident on the rear surface of the optical lenses passes through the optical lenses 230 in the first linear polarization (0) direction as they are according to the refractive index in the shorter axis direction of the optical lenses 230.

During the 2D image display period, the display driver 120 may generate the first driving voltages so that the first driving voltages are maintained below a predetermined level (e.g., below 0 V or 5 V), to apply them to the first transparent electrode 241 and the second transparent electrode 242.

When the first driving voltages from the display driver 120 are input to the first and second transparent electrodes 241 and 242, the polarization controller 240 transmits the 2D image display light incident through the optical lenses 230 while maintaining the light paths in the first linear polarization (0) direction to the front side. As a result, the 2D image is displayed through the display panel 110 and the optical member 200 during the 2D image display period.

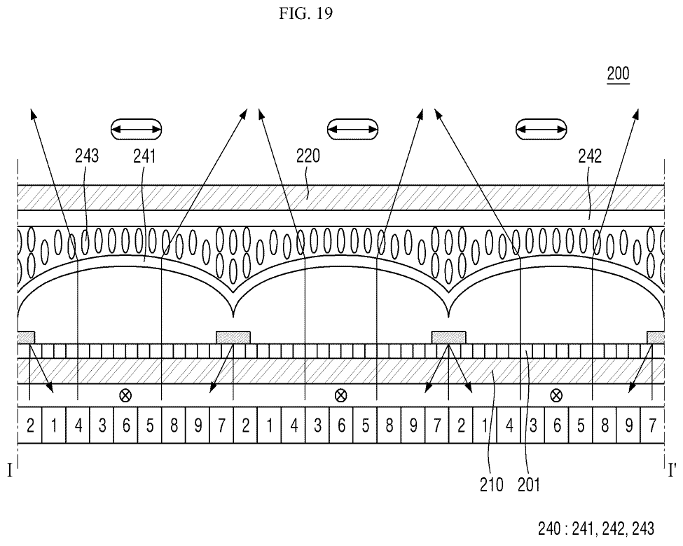

FIG. 19 is a cross-sectional view showing light exit paths of the polarization control layer and the optical lenses of the optical member according to an embodiment during a 3D image display period.

Referring to FIG. 19, during a 3D stereoscopic image display period, the display driver 120 provides 3D image data voltages (e.g., MLD and MRD) for displaying a 3D stereoscopic image for each first frame period 1Frame or the first and second sub-frames SF1 and SF2 to the data lines of the display panel 110.

All of the first to third sub-pixels SP1, SP2 and SP3 disposed in the display area DA of the display panel 110 may emit 2D image display light in the first linear polarization light (0) direction to the front side according to the orientations of the polarizing sheet 201 disposed on the front surface.

The 2D image display light in the first linear polarization (0) direction which has passed through the polarizing sheet 201 is incident on the rear surfaces of the optical lenses 230. The 2D image display light in the first linear polarization (0) direction incident on the rear surface of the optical lenses pass through the optical lenses 230 in the first linear polarization (0) direction as they are according to the refractive index in the shorter axis direction of the optical lenses 230.

The display driver 120 may generate the first and second driving voltages to provide them to the first transparent electrodes 241 and the second transparent electrodes 242, respectively, so that the difference between the first driving voltage and the second driving voltage is maintained at the predetermined voltage difference or more.

When the first driving voltage and the second driving voltage from the display driver 120 are input to the first transparent electrodes 241 and the second transparent electrodes 242 respectively, the polarization control layer 243 interposed between the first transparent electrodes 241 and the second transparent electrodes 242 is converted to have a refractive index in the longer axis direction of birefringent materials such as liquid crystals. When 2D image display light in the first linear polarization (⊗) direction is incident on the polarization controller 240 through the optical lenses 230, the polarization control layer 243 has the refractive index in the longer axis direction of liquid crystal, and thus the 2D image display light in the first linear polarization (⊗) direction is refracted toward the respective viewing points in the polarization control layer 243 and at the boundary between the polarization control layer 243 and the optical lenses 230, to exit in the refracted directions, respectively.

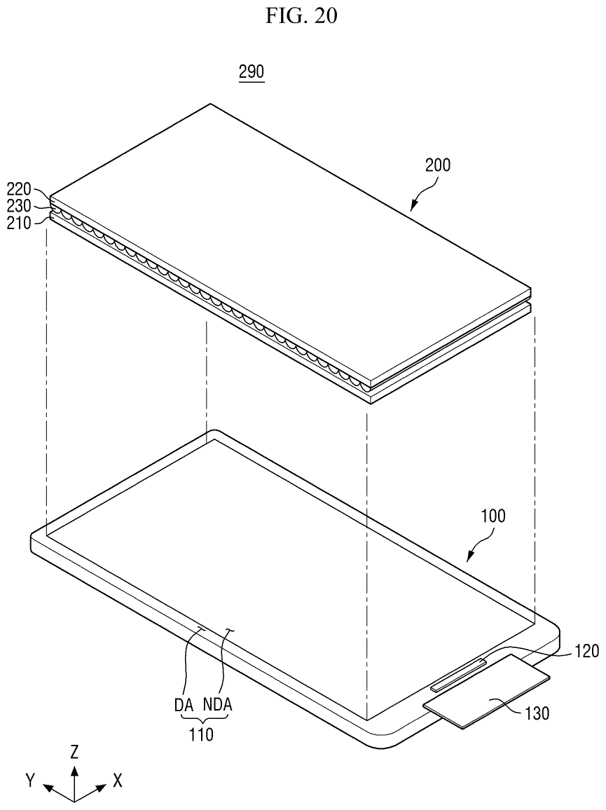

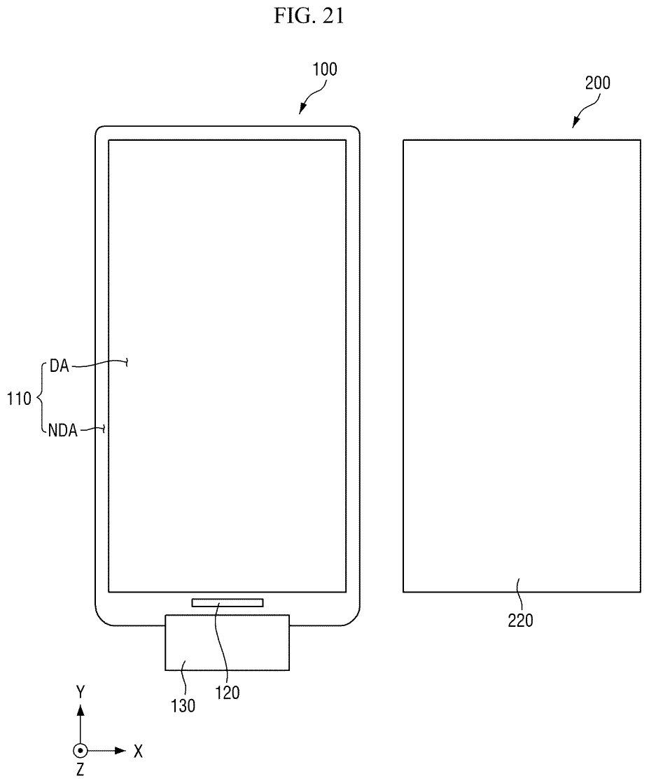

FIG. 20 is an exploded, perspective view showing a display device according to an embodiment of the present disclosure. FIG. 21 is a plan view showing the display panel and the optical member shown in FIG. 20.

Referring to FIGS. 20 and 21, a display device 290 according to an embodiment may be implemented as a flat-panel display device such as an organic light-emitting display (OLED), and may be a 3D display including the display module 100 and the optical member 200.

The display module 100 may include a display panel 110, a display driver 120, and a circuit board.

The display panel 110 may include a display area DA and a non-display area NDA. The display area DA may include data lines, scan lines, supply voltage lines, and a plurality of pixels connected to the data lines and scan lines.

The optical member 200 may be disposed on the display module 100. The optical member 200 may be attached to a surface of the display module 100 through an adhesive member. The optical member 200 may be attached to the display module 100 by a panel bonding apparatus. For example, the optical member 200 may include a polarization controller 240 and a plurality of optical lenses (e.g., refractive-index anisotropic lenses) 230 between the first and second optical sheets 210 and 220, which overlap with each other and are stacked on each other.

During the 2D image display period, the optical member 200 outputs the display light of the 2D images displayed in the display area DA of the display panel 110 along the light paths in the first linear polarization direction without changing the paths under the control of the display driver 120. In an embodiment, during the 3D stereoscopic image display period, the optical member 200 converts the display light of the 2D images displayed in the display area DA into light paths in the second linear polarization direction and refracts them under the control of the display driver 120, to output the light and display 3D stereoscopic images.

In concluding the detailed description, those skilled in the art will appreciate that many variations and modifications can be made to the described embodiments without substantially departing from the principles of the present disclosure.

What is claimed is:

1. A display device comprising:
a display panel configured to display two-dimensional (2D) images;
an optical member configured to display the 2D images displayed on the display panel by maintaining display light paths of the 2D images during a 2D image display period, and to display three-dimensional (3D) stereoscopic images by refracting the display light paths of the 2D images during a 3D stereoscopic image display period; and
a display driver configured to drive the display panel so that the display panel displays multi-view images in the 2D image display period and the 3D stereoscopic image display period, and to apply driving voltages to the optical member to control operations of the optical member for displaying the 2D images or 3D stereoscopic images.

2. The display device of claim 1, wherein the optical member comprises:
first and second optical sheets facing each other;
a polarization controller disposed between the first and second optical sheets and formed on a front surface of the first optical sheet; and
a plurality of optical lenses disposed on a rear surface of the second optical sheet to overlap with the polarization controller between the first and second optical sheets.

3. The display device of claim 2, wherein the polarization controller comprises:
at least one first transparent electrode disposed on a front surface of the first optical sheet;
a polarization control layer formed on a front surface of the at least one first transparent electrode; and
at least one second transparent electrode disposed to face the at least one first transparent electrode,
wherein the polarization control layer interposed between the at least one first transparent electrode and the at least one second transparent electrode.

4. The display device of claim 3, wherein the polarization control layer comprises birefringent materials having refractive-index anisotropy, and
wherein the birefringent materials form light paths in a first linear polarization direction when voltage levels of the at least one first transparent electrode and the at least one second transparent electrode are equal to each other or less than a predetermined voltage difference, and form light paths in a second linear polarization direction when a voltage difference between the at least one first transparent electrode and the at least one second transparent electrode is greater than the predetermined voltage difference.

5. The display device of claim 3, wherein at least one of the first and second transparent electrodes is disposed to a cover a same surface of the optical lenses.

6. The display device of claim 3, wherein the display driver divides each frame for displaying the 2D images into first and second time-division frames, and applies the same driving voltages to the first and second transparent electrodes every first and second time-division frames, to control the polarization control layer so that it maintains the light paths in the first linear polarization direction.

7. The display device of claim 3, wherein the display driver divides each frame for displaying the 3D images into first and second time-division frames, and applies a first driving voltage of the driving voltages to the at least one first transparent electrode and a second driving voltage of the driving voltages to the second transparent electrode every first and second time-division frames, to control the polarization control layer so that it forms light paths in the second linear polarization direction, and
wherein the first and second driving voltages are voltages of different levels having a predetermined voltage difference.

8. The display device of claim 2, wherein the optical lenses are configured to form light paths in a first linear polarization direction according to a material of the optical lenses or an arrangement of birefringent materials therein,
wherein 2D image display light incident along the light paths in the first linear polarization direction through the polarization controller transmit along the light paths in the first linear polarization direction, and
wherein 2D image display light incident along the light paths in the second linear polarization direction through the polarization controller are output as 3D stereoscopic images according to the material of the optical lenses or the arrangement of the birefringent materials.

9. The display device of claim 2, wherein the optical member further comprises a plurality of light-blocking patterns disposed on a rear side of the second optical sheet to overlap contact areas between adjacent ones of the optical lenses and side edges of the optical lenses, respectively.

10. The display device of claim 2, wherein the optical member further comprises a plurality of light-blocking patterns disposed on a front side of the first optical sheet to overlap contact areas between adjacent ones of the optical lenses and side edges of the optical lenses.

11. The display device of claim 1, wherein the optical member comprises:
first and second optical sheets facing each other;
a plurality of optical lenses disposed on a front surface of the first optical sheet between the first and second optical sheets; and
a polarization controller formed on a rear surface of the second optical sheet to overlap the optical lenses between the first and second optical sheets.

12. The display device of claim 11, wherein the polarization controller comprises:
at least one first transparent electrode disposed on a front surface of the first optical sheet;
a polarization control layer disposed on a front surface of the first transparent electrode; and
at least one second transparent electrode disposed to face the at least one first transparent electrode,
wherein the polarization control layer is interposed between the at least one first transparent electrode and the at least one second transparent electrode.

13. The display device of claim 12, wherein the plurality of optical lenses is configured to form light paths in a first linear polarization direction according to a material of the optical lenses or an arrangement of birefringent materials therein, and to transmit 2D image display light incident along light paths in the first linear polarization direction through the display panel without changing the light paths.

14. The display device of claim 13, wherein the polarization control layer comprises birefringent materials having refractive-index anisotropy, and
wherein the birefringent materials of the polarization control layer form light paths in a first linear polarization direction when voltage levels of the at least one first transparent electrode and the at least one second transparent electrode are equal to each other or less than a predetermined voltage difference, and form light paths in a second linear polarization direction when a voltage difference between the at least one first transparent electrode and the at least one second transparent electrode is greater than the predetermined voltage difference.

15. The display device of claim 11, wherein the optical member further comprises a plurality of light-blocking patterns disposed on a rear side of the second optical sheet to overlap with contact areas between adjacent ones of the optical lenses and side edges of the optical lenses.

16. The display device of claim 11, wherein the optical member further comprises a plurality of light-blocking patterns disposed on a front side of the first optical sheet to overlap with contact areas between adjacent ones of the optical lenses and side edges of the optical lenses.

17. A display device comprising:
a display panel configured to display two-dimensional (2D) images;
an optical member configured to display the 2D images displayed on the display panel by maintaining display light paths of the 2D images during a 2D image display period, and to display three-dimensional (3D) stereoscopic images by refracting the display light paths of the 2D images during a 3D stereoscopic image display period; and
a display driver configured to control the optical member for changing the light paths between the first and the second linear polarization directions in the second 2D image display period or the 3D stereoscopic image display period,
wherein the display driver drives the display panel so that the display panel displays multi-view images in the 2D image display period and the 3D stereoscopic image display period, and to apply driving voltages to the optical member to control operations of the optical member for displaying the 2D images or 3D stereoscopic images.

18. A display device comprising:
an optical member configured to display two-dimensional (2D) images displayed on a display panel by maintaining display light paths of the 2D images during a 2D image display period, and to display three-dimensional (3D) stereoscopic images by refracting the display light paths of the 2D images during a 3D stereoscopic image display period, wherein the optical member comprises: first and second optical sheets facing each other;
a polarization controller disposed between the first and second optical sheets on a front surface of the first optical sheet; and
a plurality of optical lenses disposed on a rear surface of the second optical sheet to overlap with the polarization controller between the first and second optical sheets.

19. The display device of claim 18, wherein the polarization controller comprises:
at least one first transparent electrode disposed on a front surface of the first optical sheet;
a polarization control layer disposed on a front surface of the first transparent electrode; and
at least one second transparent electrode disposed to face the at least one first transparent electrode,
wherein the polarization control layer interposed between the at least one first transparent electrode and the at least one second transparent electrode.

20. The display device of claim 19, wherein the polarization control layer comprises birefringent materials having refractive-index anisotropy, and
wherein the birefringent materials of the polarization control layer form light paths in a first linear polarization direction when voltage levels of the at least one first transparent electrode and the at least one second transparent electrode are equal to each other or less than a predetermined voltage difference, and form light paths in a second linear polarization direction when a voltage difference between the at least one first transparent electrode and the at least one second transparent electrode is greater than the predetermined voltage difference.
